(19) United States
(12) Patent Application Publication
(10) Pub. No.: US 2007/0208710 A1
(43) Pub. Date: Sep. 6, 2007

(54) METHOD AND APPARATUS FOR SEARCHING FOR CONTENT FILE AND RECORDING MEDIUM STORING PROGRAM FOR EXECUTING METHOD THEREOF

(75) Inventors: Hee-jeong BAE, Osan-si (KR); Bong-hyun CHO, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/611,292

(22) Filed: Dec. 15, 2006

(30) Foreign Application Priority Data
Mar. 2, 2006 (KR) 10-2006-0019917

(51) Int. Cl. G06F 17/30

(52) U.S. Cl. 707/3

(57) ABSTRACT

A method and apparatus for rapidly searching for a content file, and a recording medium storing a program for executing the method thereof are provided. The content file search method includes: displaying a content file list in which content files stored in a content file playback system are sorted based on a sorting rule; when one of a first pair of direction keys included in the content file playback system is controlled moving a search position based on category determined by the sorting rule,; and when one of a second pair of direction keys included in the content file playback system is controlled moving the search position based on content file.

### CROSS-REFERENCE TO RELATED PATENT APPLICATION

This application claims priority from Korean Patent Application No. 10-2006-0019917, filed on Mar. 2, 2006, in the Korean Intellectual Property Office, the disclosure of which is incorporated herein in its entirety by reference.

### BACKGROUND OF THE INVENTION

1. Field of the Invention

The present invention relates to a method and apparatus for searching for a content file and a recording medium storing a program for executing the method thereof, and more particularly, to a method and apparatus for searching for a content file, in which a desired content file can be rapidly searched for in a content file playback system capable of displaying a content file list in which content files are sorted in a specific order, and a recording medium storing a program for executing the method thereof.

2. Description of the Related Art

With the development of large capacity content file playback systems, such as MP3 players, content file playback systems can store more content files. For fast file searching, the content files stored in the content file playback systems are sorted using a specific sorting method.

The sorting method above provides information on a location of a content file, but the search location has to be scrolled by using up/down keys in order to access a desired content file. For this reason, if a content file to be accessed is located in the middle of a content file list, more time is required to search for that specific content file. The more content files stored in the content file playback system, the more time is required to reach a specific file.

### SUMMARY OF THE INVENTION

The present invention provides a method and apparatus for rapidly searching for a content file, and a recording medium storing a program for executing the method thereof.

The present invention also provides a method and apparatus for searching for a content file, in which a desired content file can be rapidly searched for in a content file playback system capable of displaying a content file list in which content files are sorted in a specific order. According to various embodiments of the invention, a recording medium storing a program for executing the method thereof is also provided.

According to an aspect of the present invention, there is provided a content file search method in a content file playback system, comprising: displaying a content file list in which content files stored in the content file playback system are sorted based on a sorting rule; moving a search position based on category determined by the sorting rule, when one of a first pair of direction keys included in the content file playback system is controlled; and moving the search position based on content file, when one of a second pair of direction keys included in the content file playback system is controlled.

According to another aspect of the present invention, there is provided a content file search apparatus comprising: a function key group having at least a first pair of direction keys and a second pair of direction keys; a storage unit storing one or more content files; a display unit displaying a content file list in which the content files stored in the storage unit are sorted based on a sorting rule; and a controller which moves a search position based on category determined by the sorting rule when the content file list is displayed and one of a first pair of direction keys is controlled; and moving the search position based on content file when one of a second pair of direction keys included in the content file playback system is controlled.

According to another aspect of the present invention, there is provided a computer-readable medium having embodied thereon a computer program for executing a content file search method in a content file playback system, the medium comprising: code for displaying a content file list in which content files stored in the content file playback system are sorted based on a sorting rule; a code for moving a search position based on category determined by the sorting rule when one of a first pair of direction keys included in the content file playback system is controlled; and code for moving the search position based on content file, when one of a second pair of direction keys included in the content file playback system is controlled.

Additional aspects related to the invention will be set forth in part in the description which follows, and in part will be apparent from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The above and other features and advantages of the present invention will become more apparent by describing in detail exemplary embodiments thereof with reference to the attached drawings in which:

FIG. 1 is a functional block diagram of a content file search apparatus according to an embodiment of the present invention;

FIG. 2 illustrates an example of a search screen used in the content file search apparatus of FIG. 1;

FIG. 3 is a functional block diagram of a content file search apparatus according to another embodiment of the present invention;

FIG. 4 is an example of a search screen used in the content file search apparatus of FIG. 3;

FIG. 5 is a flowchart illustrating an operation of a content file search method according to another embodiment of the present invention;

FIG. 6 is a flowchart illustrating the operation of a content file search method according to another embodiment of the present invention;

FIG. 7 is a flowchart illustrating a content file search method according to another embodiment of the present invention;

FIG. 8 is a flowchart illustrating an operation of a content file search method according to another embodiment of the present invention; and

FIG. 9 is a flowchart illustrating a content file search method according to another embodiment of the present invention.

### DETAILED DESCRIPTION OF THE INVENTION

Hereinafter, the present invention will be described in detail by explaining exemplary embodiments of the invention with reference to the attached drawings.

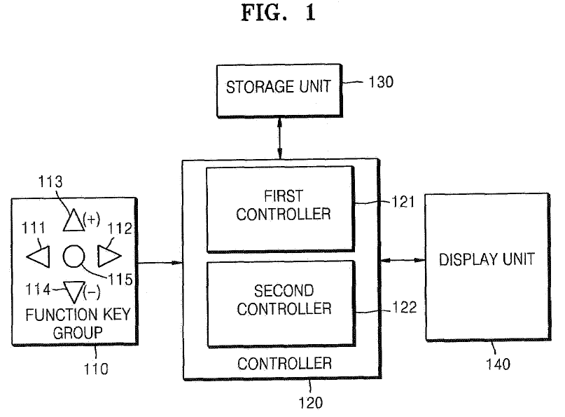

FIG. 1 is a functional block diagram of a content file search apparatus according to an embodiment of the present invention. The content file search apparatus of FIG. 1 may be included in a content file playback system such as an MP3 player, in which case the content files would be audio files, or an MP4 player, in which case the content files may be video and/or audio files. Referring to FIG. 1, the content file search apparatus includes a function key group 110, a controller 120, a storage unit 130, and a display unit 140.

The function key group 110 includes at least a first pair of direction keys and a second pair of direction keys. Referring to FIG. 1, the function key group 110 includes a left key ( [symbol] ) 111, a right key ( [symbol] ) 112, an up key (Δ(+)) 113, a down key (∇(−)) 114, and a selection key 115. If the first pair of direction keys is the left/right keys 111 and 112 of FIG. 1, the second pair of direction keys is the up/down keys 113 and 114, whereas if the first pair of direction keys is the up/down keys 113 and 114, the second pair of direction keys is the left/right keys 111 and 112. The selection key 115 is used to select a found content file so as to be played back. In the embodiments of the present invention, it will be assumed that the first pair of direction keys is the left/right keys 111 and 112, and the second pair of direction keys is the up/down keys 113 and 114.

The storage unit 130 stores one or more content files.

The display unit 140 displays a content file list in which content files stored in the storage unit 130 are sorted in a specific order.

When the content file list is displayed through the display unit 140, and one of the first pair of direction keys included in the function key group 110 is controlled, the controller 120 moves a search position by a category determined according to a sorting rule, and when one of the second pair of direction keys is controlled, the controller 120 moves the search position by a content file.

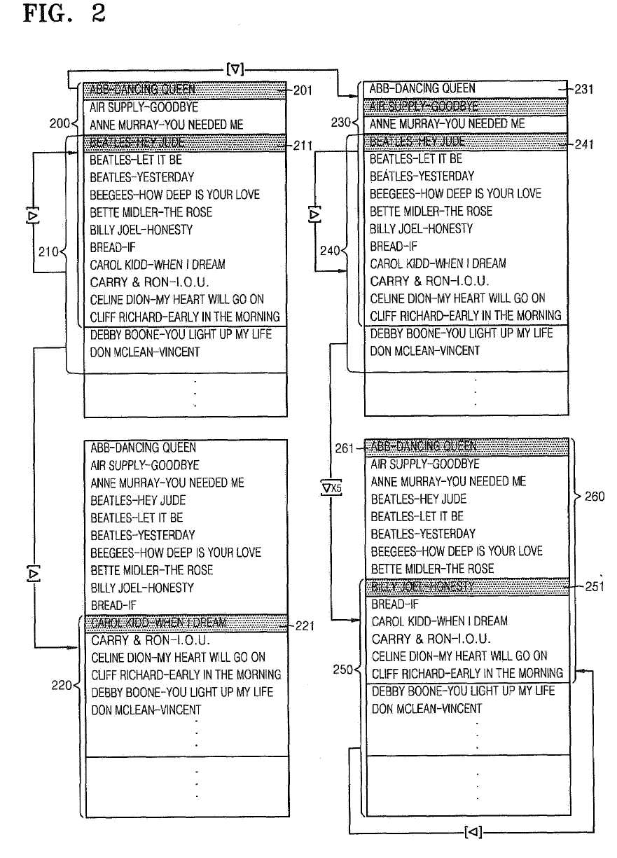

FIG. 2 illustrates an example of a search screen used in the content file search apparatus of FIG. 1. The operation of the controller 120 will now be described in detail with reference to FIG. 2.

A content file list 200 is displayed through the display unit 140, and a content file 201 is highlighted. In this case, when the right key 112 of the left/right keys 111 and 112 included in the function key group 110 is clicked one time, the content file list 200 displayed on the display unit 140 changes into a content file list 210, and a content file 211 is highlighted. In this operation, the highlighted position is a current search position.

Content file lists of FIG. 2 area an example in which the names of the artists and alphabetical order are used as a sorting rule for audio content files. In this operation, the names of the artists are categorized in alphabetical order. For example, content files in which a name of an artist starts with an A are categorized as a first category, content files in which a name of an artist starts with a B are categorized as a second category, and content files in which a name of an artist starts with a C are categorized as a third category. The categories are arranged in escalating order, so that the first category is presented before the second category; the third category is listed after the second category, etc.

The categories may change when the sorting rule changes. The sorting rule may be determined to be, e.g., song titles in alphabetical order, and genre names in alphabetical order, etc. According to a determined sorting rule, the categories may change. In the case of an alphabetically sorted content file list, a category may be determined based on a first character in alphabetical order.

With a content file list included in the content file list 210 of FIG. 2 being displayed, if the right key 112 of the function key group 110 is clicked one more time, the display changes to the next content list, i.e., the content file list displayed on the display unit 140 changes from the content file list 210 into a content file list 220, and the first content file in that category, i.e., content file 221, is highlighted.

Whereas, with the content file list 210 of FIG. 2 being displayed, if the left key 111 of the function key group 110 is clicked one more time, the display reverts to the previous category, i.e., the content file list displayed on the display unit 140 changes from the content file list 210 into the content file list 200, and the first content file 201 in this category is highlighted.

Meanwhile, when the down key 114 of the function key group 110 is clicked one time in a state that the content file 201 is highlighted in the content file list 200, the controller 120 displays on the display unit 140 the next content file in the displayed category, e.g., a content file list 230 in which a content file 231 is highlighted.

When the right key 112 of the function key group 110 is clicked one time in a state that the content file list 230 is displayed on the display unit 140, a content file list 240 in which a content file 241 is highlighted is displayed on the display unit 140.

When the down key 114 of the function key group 110 is clicked five times in a state that the content file list 240 is displayed on the display unit 140, a content file list 250 in which a content file 251 is highlighted is displayed on the display unit 140.

When the left key 111 of the function key group 110 is clicked in a state that the content file list 250 is displayed on the display unit 140, the display reverts to the previous category highlighting the first content file in this category, i.e., a content file list 260 in which a content file 261 is highlighted is displayed on the display unit 140.

Accordingly, FIG. 2 shows an example of changing a search position based on category by using the left and right keys 111 and 112. Here, when the search position moves to a first content file in each category, the first content file is highlighted.

In the aforementioned example, the function keys 111 to 114 included in the function key group 110 are clicked, i.e., depressed for a short time period (hereinafter referred to as a short mode). However, in the controller 120, the function keys 111 to 114 included in the function key group 110 may be clicked or depressed for a long time period (hereinafter referred to as a long mode). If the short mode and the long mode are both enabled, the controller 120 decides whether the function keys are controlled in the short mode or in the long mode according to a predetermined control period for the function keys 111 to 114 included in the function key group 110. The information on the predetermined control period may be defined to be information on time.

In the short mode, the controller 120 operates based on the number of control times, i.e., clicks, as described above with reference to FIG. 2. However, in the long mode, the search position may be continuously moved based on category or content file.

In other words, when one of the first pair of direction keys (the left key 111 or the right key 112) is controlled in the long mode, e.g., click and hold, the controller 120 continuously performs the operation of moving the search position based on category. For example, if the right key 112 is controlled in the long mode, e.g., click and hold, in a state that the content file list 200 is displayed on the display unit 140, the content file lists displayed on the display unit 140 move rapidly in sequence in the order 200, 210, and 220 (downwards), thereby moving the search position for a content file. On the other hand, if the left key 111 is controlled in the long mode in a state that the content file list 220 is displayed on the display unit 140, the content file lists displayed on the display unit 140 move rapidly in sequence in the order 220, 210, and 200 (upwards), thereby moving the search position for a content file.

When one of the second pair of direction keys (the up key 113 or the down key 114) is controlled in the long mode, the controller 120 continuously performs the operation of moving the search position based on content file, i.e., the controller performs rapid scroll of the content files in ascending or descending order. For example, if the down key 114 is controlled in the long mode in a state that the content file list 240 is displayed on the display unit 140, the search position for a content file list displayed on the display unit 140 moves continuously and rapidly to a next content file items. On the other hand, if the up key 113 is controlled in the long mode in a state that the content file list 240 is displayed on the display unit 140, the search position for the content file list displayed on the display unit 140 moves continuously and rapidly to the previous content file items.

In order to perform the operation mentioned above, the controller 120 can include a first controller 121 for moving the search position and a second controller 122 for moving the search position.

Under the control of the first controller 121, a search position moves in the content file list on the category basis by using the first pair of direction keys. The first controller 121 may operate by distinguishing between the short mode and the long mode, or operate according to the number of control times of the direction keys, i.e., the number of clicks, regardless of the long mode or the short mode.

Under the control of the second controller 122, the search position moves in the content file list on the content file basis by using the second pair of direction keys. The second controller 122 may also operate by distinguishing between the short mode and the long mode, or operate according to the number of control times of the direction keys regardless of the long mode or the short mode.

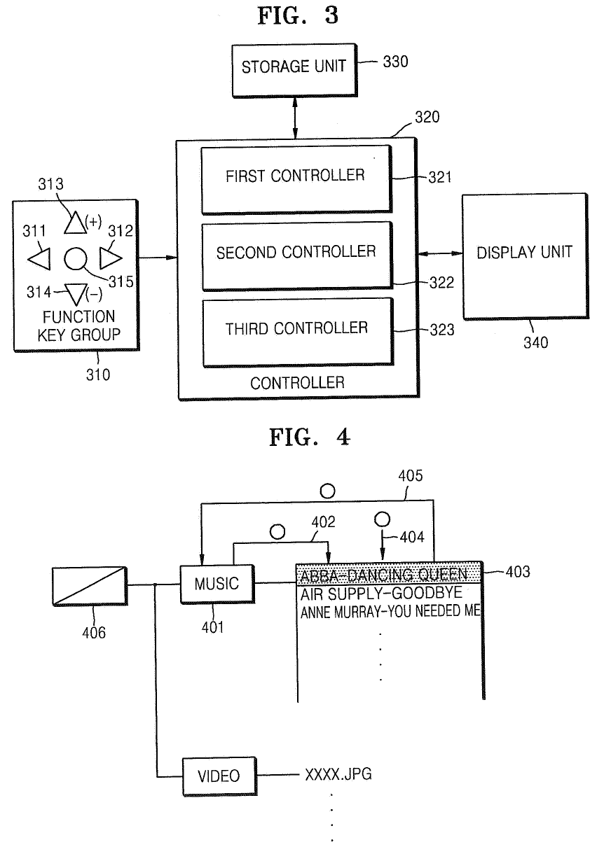

FIG. 3 is a functional block diagram of a content file search apparatus according to another embodiment of the present invention. Referring to FIG. 3, the content file search apparatus includes a function key group 310, a controller 320, a storage unit 330, and a display unit 340. The structures and operations of the function key group 310, the storage unit 330, and the display unit 340 are the same as the function key group 110, the storage unit 130, and the display unit 140 of the previous embodiment.

The controller 320 further includes a function controlled by a selection key 315 included in the function key group 310, in addition to the function of the controller 120 of FIG. 1. According to a control period of the selection key 315, the controller 320 moves a search position to an upper or lower level by checking a position (highlighted position) controlled by the selection key 315 in a content file list displayed on the display unit 340. Alternatively, a content file is played back through the selection key 315.

When the selection key 315 is controlled in the short mode and a folder is highlighted in the content file list, the controller 320 moves a highlighted position displayed on the display unit 340 to the lower level. Whereas, when the selection key 315 is controlled in the short mode and the content file is highlighted in the content file list, the controller 320 may playback the highlighted content file. When the selection key 315 is controlled in the long mode, the search position moves to the upper level regardless whether a folder or a content file is highlighted in a content file list.

FIG. 4 is an example of a search screen used in the content file search apparatus of FIG. 3, where a content file list is searched under the control of the selection key 315 above. Referring to FIG. 4, when the selection key 315 is controlled in the short mode in a state that a content file list is displayed on the display unit 340, with a folder 401 being highlighted, then the controller 320 displays the content file list in which a content file 403 is highlighted, where a highlight indication is illustrated by arrow 402. In this state, when the selection key 315 is controlled in the short mode, i.e., rapid click and release, the controller 320 plays back the content file 403.

On the other hand, if the selection key 315 is controlled in the long mode, i.e., click and hold for elongated period, in a state that the content file 403 is highlighted, the controller 320 displays the content file list on the display unit 340, where the highlight indication is illustrated by arrow 405.

In order to perform the above functions, the controller 320 includes a first controller 321 for moving the search position, a second controller 322 for moving the search position, and a third controller 323 for moving the search position. The structures and operations of the first and second controllers 321 and 322 are the same as the first and second controllers 121 and 122 of FIG. 1.

According to the control period of the selection key 315, the third controller 323 moves a search position to an upper or lower level by checking a position (highlighted position) controlled by the selection key 315 in a content file list displayed on the display unit 340. Alternatively, a content file is played back through the selection key 315.

As can be understood, the first, second, and third controllers need not be necessarily separate hardware parts. Rather, each or any of the controllers may be implemented as an individual hardware unit, a combined hardware unit, a combination of hardware and software, or a software that runs on one or more processors.

The function key groups 110 and 310 shown in FIGS. 1 and 3, respectively, may further include a sorting rule change request key for requesting a change of a sorting rule of the content file list. In addition, a sorting rule change function can be performed using one of the keys included in the function keys groups 110 and 310. That is, one of the keys included in the function key groups 110 and 310 can be defined as the sorting rule change request key. For example, the content file search apparatus in FIG. 3 can comprise the controller 320 which can recognize that a change of a sorting rule is requested, when the selection key 315 is pressed twice. If the selection key 315 is used as the sorting rule change request key, the selection key 315 can be a key for performing a plurality of functions. However, in order to perform the sorting rule change function, a pressing operation on the selection key 315 can be defined as one of a variety of pressing operations, e.g. an elongated press, pressing twice, etc.

If a change of a sorting rule is requested by controlling the sorting rule change request key in the function key groups 110 and 310, the controllers 120 and 320, respectively, display a sorting rule list on the display units 140 and 340 based on several sorting rules data pre-stored in the storage units 130 and 330. Then, if the left/right keys 111 and 112, and 311 and 312 or the up/down keys 113 and 114, and 313 and 414 included in the function key groups 110 and 310, respectively, are pressed by a user, controllers 120 and 320, respectively, move a cursor on the sorting rule list displayed on the display units 140 and 340. When the selection keys 115 and 315, respectively, are pressed by a user, the controllers 120 and 320, respectively, change the sorting rule of the content file list into a sorting rule over which the cursor is placed on the sorting rule list, and then the controllers 120 and 320 re-sort the content file list based on the changed sorting rule. Accordingly, display units 140 and 340 display the re-sorted content file list.

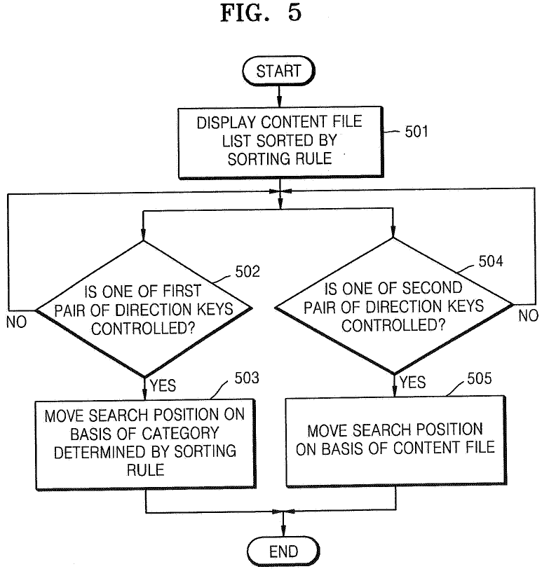

FIG. 5 is a flowchart illustrating the operation of a content file search method according to another embodiment of the present invention. The operation of FIG. 5 will now be described with reference to FIG. 1.

First, the controller 120 displays a content file list in which content files stored in a content file playing back system are sorted by a sorting rule (operation 501).

When one of the first pair of direction keys included in the content file playback system is controlled, controller 120 moves the search position based on category determined by a sorting rule (operations 502 and 503), and completes a search operation for the content file. In the operation of moving the search position based on category, the search position moves to a first content file in each category as described with reference to FIG. 2.

When one of the second pair of direction keys included in the content file playback system is controlled, the controller 120 moves the search position based on content file (operations 504 and 505), and completes a search operation for the content file.

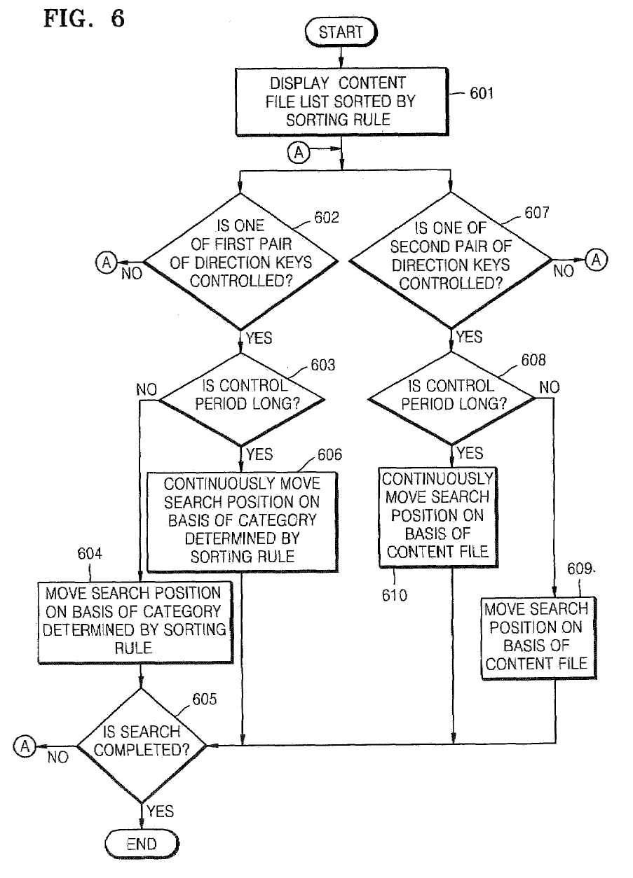

FIG. 6 is a flowchart illustrating the operation of a content file search method according to another embodiment of the present invention. Unlike FIG. 5, an example of controlling direction keys by distinguishing between a short mode and a long mode are shown in FIG. 6. The operation of FIG. 6 will now be described with reference to FIG. 1.

First, the controller 120 displays a content file list in which content files stored in a content file playing back system are sorted by a sorting rule (operation 601).

When one of the first pair of direction keys included in the content file playback system is controlled, the controller 120 checks whether the direction key is controlled in the long mode (operations 602 and 603). If it is not in the long mode, the controller 120 moves the search position by one based on category determined according to a sorting rule (operations 603 and 604).

Next, the controller 120 checks whether searching completion for a content file is requested (operation 605). If there is no such request, the controller 120 performs the aforementioned processes and goes back to A. However, if there is such request, the controller 120 completes the search operation for the content file.

If a direction key in operation 603 is controlled in the long mode, the controller 120 continuously performs the operation of moving the search position based on category (operation 606). As described above with reference to FIGS. 1 and 2, the content file list changes rapidly in sequence in the order 200, 210, and 220, and the search position for the content file moves. Such continuously scrolling operation may stop when the control of the direction key is completed. When the continuously scrolling operation stops, operation 605 is performed.

When one of the second pair of direction keys included in the content file playback system is controlled, the controller 120 checks whether the direction key is controlled in the long mode (operations 607 and 608). If it is not in the long mode, the search position moves based on content file (operations 608 and 609), and operation 605 is performed.

If the direction key is operated in the long mode in operation 608, the controller 120 continuously performs the operation for moving the search position based on content file (operation 610). Such continuously scrolling operation may stop when the control of the direction key is completed. When the continuously scrolling operation stops, the controller 120 performs operation 605.

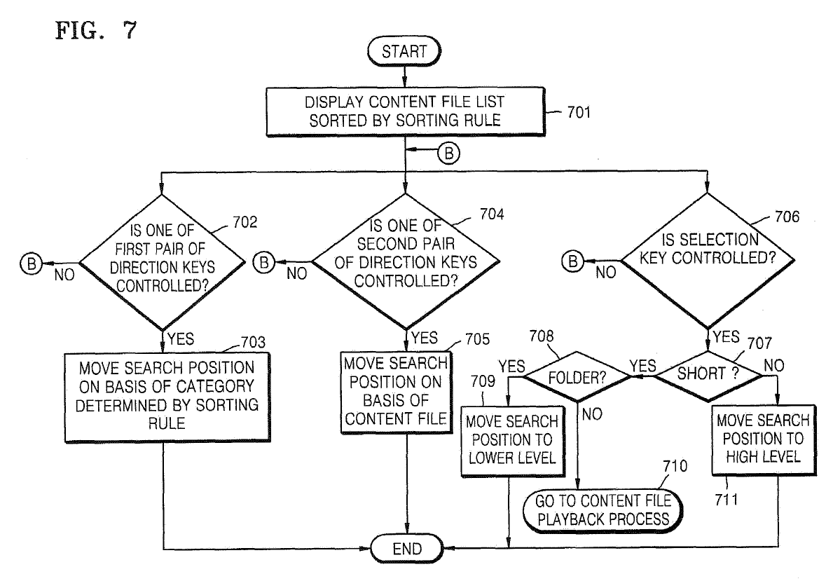

FIG. 7 is a flowchart illustrating a content file search method according to another embodiment of the present invention. Unlike FIG. 5, a function controlled by selection keys is further included in FIG. 7. Thus, operations 701 to 705 are the same as operations 501 to 505 of FIG. 5. The operations of FIG. 7 will now be described in detail with reference to FIG. 3.

When the selection key 315 is controlled (operation 706), the controller 320 checks whether the selection key 315 is controlled in a short mode of control period (operation 707). As a result, if it is in the short mode, the controller 320 checks whether the selection key 315 is controlled to indicate a folder in a content file list displayed on the display unit 340 (operation 708). If the folder is indicated, the controller 320 moves the search position to a lower level in the content file list (operation 709). Accordingly, the highlight indication moves to the lower level, and the controller 320 completes the operation of searching for the content file.

If the content file, not a folder, is selected under the control of the selection key 315, i.e., the response is “no” in operation 708, the controller 320 performs a process of playing back the content file in operation 710.

If it is determined that the control of the selection key 315 is not in the short mode but the long mode in operation 707, the controller 320 moves the search position to the upper level in the content file list as described with reference to FIGS. 3 and 4. Accordingly, the highlight indication moves to the upper level.

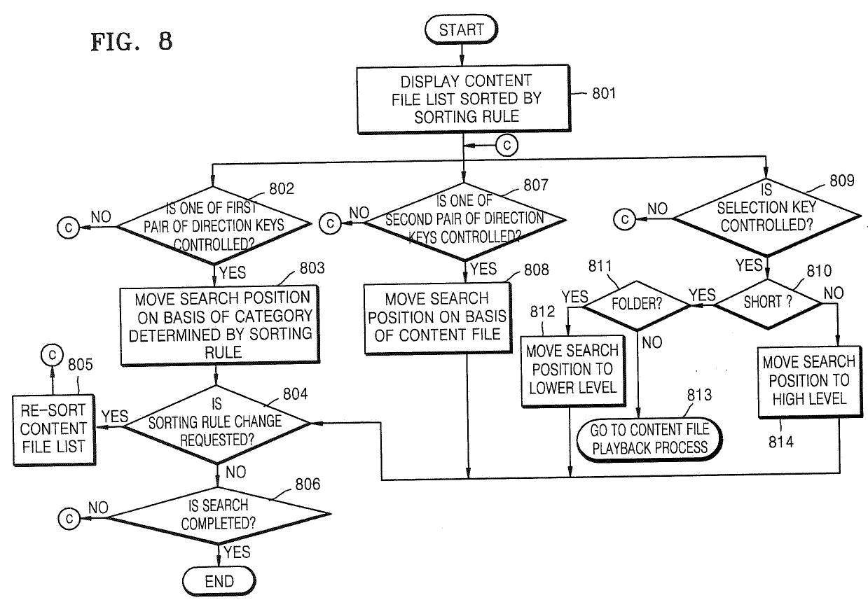

FIG. 8 is a flowchart illustrating the operation of a content file search method according to another embodiment of the present invention. A function that changes a sorting rule of a content file list displayed while performing the content file search method of FIG. 7 is further included in FIG. 8

Thus, operations 801 to 803 and 807 to 814 of FIG. 8 are the same as operations 701 to 711 of FIG. 7.

If change of a sorting rule is requested in operation 804, the controller 320 displays a content file list on the display unit 340 after re-sorting the content file list based on the sorting rule according to the change request, in operation 805. For example, a current content file list is sorted in alphabetical order based on name of an artist as shown in FIG. 2, and a sorting rule is requested to be changed from name of an artist to song title, the controller 320 re-sorts the displayed content file list in alphabetical order based on the song title. In this operation, a category is determined according to the changed sorting rule. Thereafter, the operation of the controller 320 proceeds to step C. The re-sorting process of the content file list is similar to the re-sorting process of the content file list described in FIGS. 1 and 3.

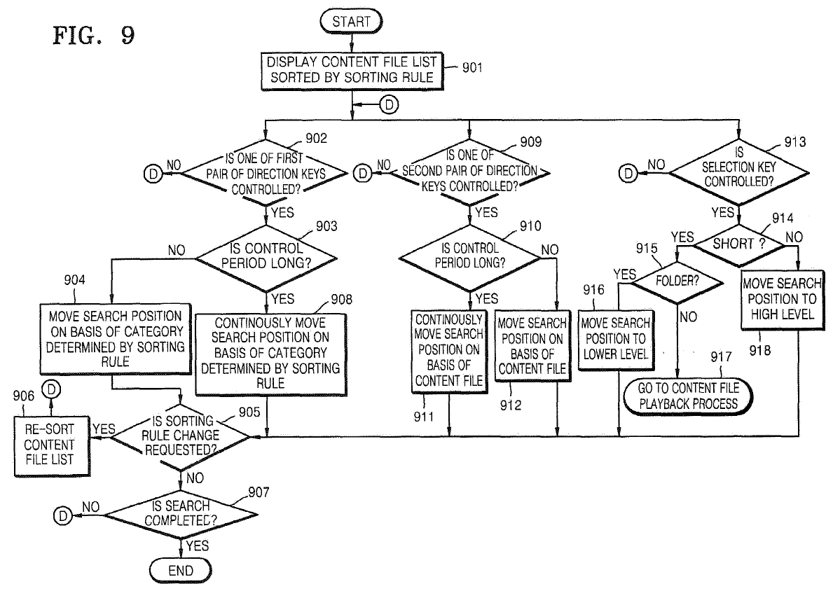

FIG. 9 is a flowchart illustrating a content file search method according to another embodiment of the present invention. An example of a content file search method in which the content file search method of FIG. 6 and the content file search method of FIG. 8 are combined is shown in FIG. 9.

The operations 901 to 904, 908, 909 to 912 of FIG. 9 are the same as operations 601 to 609 of FIG. 6. The operations 905 to 906 are the same as operations 804 to 806 of FIG. 8. Operations 913 to 918 of FIG. 9 are the same as operations 804 to 809 of FIG. 8.

Therefore, in FIG. 9, according to whether direction keys 111 to 114 and 311 to 314 are controlled in short mode or long mode, operations are performed. The operations may be moving a search position based on category, moving a search position based on content file, moving a search position under control of the selection key 315, selecting a content file to be played back, and re-sorting a displayed content file list.

In FIG. 9, the process of re-sorting a displayed content file list performed in operations 905 and 906 of FIG. 9 may be excluded.

Accordingly, the present invention provides a content file playback system in which stored content files are sorted based on a sorting rule, a search position moves based on category determined by the sorting rule and based on content file, by using four direction keys. In addition, by using a selection key, the search position moves to an upper level or lower level of the content file list, thereby improving search speed for a content file.

The invention can also be embodied as computer readable code on a computer readable recording medium. The computer readable recording medium is any data storage device that can store data that can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A content file search method in a content file playback system, comprising:
displaying a content file list in which content files stored in the content file playback system are sorted in categories based on a sorting rule;
moving a search position based on the category determined by the sorting rule when one of a first pair of direction keys included in the content file playback system is controlled; and
moving the search position based on the content files when one of a second pair of direction keys included in the content file playback system is controlled.

2. The content file search method of claim 1, wherein when the moving of a search position is based on category, the search position moves to a first content file in each category.

3. The content file search method of claim 1, wherein, when one of the first pair of direction keys is controlled in a long mode, the moving of a search position based on category is continuously performed, and
when one of the second pair of direction keys is controlled in the long mode, the moving of a search position based on category is continuously performed.

4. The content file search method of claim 3, further comprising
performing repeatedly the moving of a search position until a searching operation for the content file is completed.

5. The content file search method of claim 4, wherein, when left/right keys of the content file playback system are used as the first pair of direction keys, up/down keys are used as the second pair of direction keys of the content file system, and
when the up/down keys of the content file playback system are used as the first pair of direction keys, the left/right keys are used as the second pair of direction keys of the content file system

6. The content file search method of claim 5, further comprising
upon detecting an input from a selection key, moving the search position to an upper level or lower level, or proceeding to a process of playing back a content file, according to the search position in the content file list at the time of the input and according to a control period of the selection key.

7. The content file search method of claim 6, further comprising
upon receiving a request for changing the sorting rule, re-sorting the content file list displayed based on the changed sorting rule,
wherein new categories are determined based on the changed sorting rule.

8. The content file search method of claim 3, further comprising
upon detecting an input from a selection key, moving the search position to an upper level or lower level, or proceeding to a process of playing back a content file, according to the search position at the time of the input and according to a control period of the selection key.

9. The content file search method of claim 1, further comprising
performing repeatedly the moving of a search position until a searching operation for the content file is completed.

10. The content file search method of claim 1, further comprising
upon detecting an input from a selection key, moving the search position to an upper level or lower level, or proceeding to a process of playing back a content file, according to the search position at the time of the input and according to a control period of the selection key.

11. A content file search apparatus comprising:
a function key group having at least a first pair of direction keys and a second pair of direction keys;
a storage unit storing one or more content files;
a display unit displaying a content file list in which the content files displayed are sorted in categories based on a sorting rule; and
a controller moving a search position based on the categories when one of the first pair of direction keys is controlled, and moving the search position based on content file when one of the second pair of direction keys is controlled.

12. The content file search apparatus of claim 11, wherein, when the search position moves based on category, the controller moves the search position to a first content file listed in each selected category.

13. The content file search apparatus of claim 12, wherein, when one of the first pair of direction keys is controlled in a long mode, the controller continuously performs the moving of the search position based on category, and
when one of the second pair of direction keys is controlled in the long mode, the controller continuously performs the moving of the search position based on category.

14. The content file search apparatus of claim 13, wherein, when the first pair of direction keys is left/right keys, the second pair of direction keys is up/down keys, and when the first pair of direction keys is up/down keys, the second pair of direction keys is left/right keys.

15. The content file search apparatus of claim 14, wherein the function key group further comprises a selection key, and
upon receiving an input from the function key, the controller moves the search position to an upper level or lower level, or proceeds to a process of playing back the content file according to the search position at the time of the input and according to a control period of the selection key.

16. The content file search apparatus of claim 13, wherein the controller further comprises:
a first controller that moves the search position of the content file list based on category under the control of the first pair of direction keys; and
a second controller that moves the search position of the content file list based on content file under the control of the second pair of direction keys.

17. The content file search apparatus of claim 16, wherein the function key group further comprises a selection key, and
the controller further comprises a third controller which moves the search position to an upper level or lower level or proceeds to a process of playing back a content file, by checking a position where a selection key is controlled in the content file list according to a control period of the selection key.

18. The content file search apparatus of claim 12, wherein the function key group further comprises a selection key, and
the controller moves the search position to an upper level or lower level, or proceeds to a process of playing back a content file by checking the search position at the time the selection key is controlled and according to a control period of the selection key.

19. The content file search apparatus of claim 11, wherein, when one of the first pair of direction keys is controlled in a long mode, the controller continuously performs the moving of the search position based on category, and
when one of the second pair of direction keys is controlled in the long mode, the controller continuously performs the moving of the search position based on content file.

20. A computer-readable medium embodied thereon a computer program for executing a content file search method in a content file playback system, the medium comprising:
code for displaying on a display a content file list in which content files stored in the content file playback system are sorted in categories based on a sorting rule;
code for moving a search position based on category determined by the sorting rule, whenever one of a first pair of direction keys included in the content file playback system is controlled; and
code for moving the search position based on content file, whenever one of a second pair of direction keys included in the content file playback system is controlled.
